(19) United States
(12) Patent Application Publication
(10) Pub. No.: US 2009/0237816 A1
(43) Pub. Date: Sep. 24, 2009

(54) Lens Holding Frame, Lens Driving Device, and Imaging Device

(75) Inventor: Yoshio Kakuta, Saitama-shi (JP)

Correspondence Address: ROTHWELL, FIGG, ERNST & MANBECK, P.C., 1425 K STREET, N.W., SUITE 800, WASHINGTON, DC, 20005, US

(73) Assignee: Tamron Co., Ltd., Saitama-shi (JP)

(21) Appl. No.: 12/409,060

(22) Filed: Mar. 23, 2009

(30) Foreign Application Priority Data
Mar. 21, 2008 (JP) JP2008-073448

(51) Int. Cl. G02B 7/04

(52) U.S. Cl. 359/823

(57) ABSTRACT

An object of the present invention is to provide a lens holding frame which enables a down-sizing, less fluctuation in a sliding motion of the lens in the direction parallel with the optical axis, and excellent durability, a lens driving device, and an imaging device. To achieve the object, the lens holding frame for holding a lens driven for image focusing comprising the main body of a lens frame and a sliding guide device connected to the outer edge of the main body; and the sliding guide device comprising a rack which transmit power transmitted from a driving source via a pinion on the surface are adopted, and are assembled to enable sliding along a guide pole provided in parallel with the optical axis in an outer peripheral part of the sliding motion path of the lens driven for image focusing to focus the image.

### BACKGROUND OF THE INVENTION

1. Field of the Invention

The present invention relates to a lens holding frame for holding a lens used for an imaging device. More particularly, the present invention relates to a lens holding frame composed of a main body of a lens frame and a sliding guide device assembled to enable sliding along the direction parallel with the optical axis in a lens frame.

2. Background Art

An imaging device such as a video camera and a digital camera has a zooming lens and a focusing lens. In the imaging device, a method to achieve a zooming or focusing effect applied popularly is that these lenses are made slide along the optical axis by using a small motor to change the focal distance and the like of the imaging device. In such method, in order to settle the focusing at all focal distances, it is required to move a lens groups for control of focal distance and a lens group for focusing independently. In this case, driving sources for moving both the lens group for control of focal distance and the lens group for focusing should be installed independently. Also, since these lens groups are required to slide on the optical axis stably with high accuracy, a lens driving mechanism tends to be complicate.

Therefore, a holding frame for holding a lens group used for the imaging device has also been required to have a construction which makes lens sliding on the optical axis stable with high accuracy, and same time, which enables small and simple lens driving mechanism.

To solve the above problems, Japanese Patent Laid-Open No. 2007-140396 disclose the lens driving device in which a flat type stepping motor and a cam is used for driving the lens. In the lens driving device disclosed in Japanese Patent Laid-Open No. 2007-140396, the motor unit comprises the plate-shaped cam fixed to the output shaft of the flat type stepping motor, and the cam is locked by the flange of an assembly support post. When the cam provided in the motor unit is rotated, the roller provided in the frame unit in contact with the roller operating face of the cam is moved along the rotation of the cam, then the lens tube directly connected to the roller and the lens disposed in the lens tube are made move.

Also, in Japanese Patent No. 2890689, an inner focusing system in which the focusing is adjusted by the lens other than a front lens, such as a master lens, is proposed in place of a focusing system using the front lens as a focusing lens for a video camera. In the lens moving apparatus disclosed in Japanese Patent No. 2890689, an external cylinder supports an internal cylinder to which a master lens group is fixed interposing ball bearing so as to be able to slide in the optical axis direction. Also, a motor mount fixed to the external cylinder comprises a motor provided with a feed screw on the drive shaft and a bearing supporting one end of the drive shaft. In the feed screw part of the drive shaft, a moving element comprising internal threads is geared, and the moving element and the internal cylinder are connected to each other by a connecting arm. In addition, the external cylinder is provided with an elongated hole extending in the optical axis direction to make the connecting arm movable in the optical axis direction. As described above, when the shaft of motor rotates, the moving element, the arm, and the internal cylinder move linear in the optical axis direction, and then the master lens group fixed to the internal cylinder performs focusing.

In Japanese Patent Laid-Open No. 2003-195144, the lens driving device that has a small hysteresis and is less liable to generate image fluctuations is proposed. The lens driving device disclosed in Japanese Patent Laid-Open No. 2003-195144 comprises guide pins for guiding the lens holding frame holding the lens in the optical axis direction, a lead screw rotated by a driving source for moving the lens holding frame in parallel with the optical axis, a sleeve settled to the main body in the optical axis direction, and a rack geared with the lead screw installed in the sleeve and are all connected. In addition, the lens driving device also comprises a clamper comprising a contact portion for transmitting a driving force to the lens holding frame in the optical axis direction when the lead screw is rotated, and a spring to push the rack gear of the clamper in the direction to gear with the lead screw, wherein the clamper is guided by the guide pin so as to move in the optical axis direction and rotate freely around the axis of the guide pins. In construction of the lens driving device, the sleeve connected to the lens holding frame is arranged close to the rotation axis direction of the lead screw via the clamper.

However, the lens driving device disclosed in Japanese Patent Laid-Open No. 2007-140396 is difficult to correct the position of lens after the shape of the cam is fixed, because the displacement in the optical axis direction of the lens frame for holding the lens depends on the shape of the cam. Therefore, optical correction on a positional shift of the lens frame caused by the deviation in manufacturing etc. of the cam shape should be performed by using another lens group. In addition, a problem exists that the moving distance cannot be made long when a cam is used.

The lens driving device disclosed in Japanese Patent No. 2890689 does not use a mechanical cam as shown in Japanese Patent Laid-Open No. 2007-140396, and the lens can be made stop at any position, and the optical correction can be made free. However, the drawback of the lens driving device described in Japanese Patent No. 2890689 is that when the driving element for moving the lens collides with the side wall, the driving element may be tightened by the feed screw provided on the drive shaft and it is hard to clear by turning the rotating direction.

In the lens driving device disclosed in Japanese Patent Laid-Open No. 2003-195144, the clamper for moving the lens is just engaged with the lead screw by the rack gear provided on the clamper, which is pushed by the spring. Therefore, even when colliding with a side wall, the clamper can leave easily. So, a phenomenon in the lens driving device disclosed in Japanese Patent No. 2890689 that the clamper is tightened on the lead screw may not occur. However, the problem of lens driving device described in Japanese Patent Laid-Open No. 2003-195144 is that a mechanism to push the rack gear of clamper to the lead screw is complicated and it cause difficulty in assembling.

As described above, various ideas and mechanisms for sliding the lens in parallel with the optical axis have been employed conventionally. However, in recent years, to achieve higher performance in a camera module, a down sized lens driving device with high durability and highly accurate operation that solves the above-described problems has been required.

### SUMMARY OF THE INVENTION

Accordingly, an object of the present invention is to provide the lens holding frame which enables a down-sizing, less fluctuation in a sliding motion of the lens in the direction parallel with the optical axis, and excellent durability, the lens driving device, and the imaging device.

The present inventor thought out the conditions for the size reduction of the lens holding frame which also assure durability and highly accurate operation as the lens driving device by providing the sliding guide device, which is connected to the lens frame body and is made able to slide along the guide pole provided in parallel with the optical axis. The present invention will be described below.

The present invention provides the lens holding frame for holding the lens driven for image focusing and made able to slide for image focusing used for the imaging device, wherein the lens holding frame is composed of a main body of the lens frame and the sliding guide device connected to the outer edge of the main body; and the sliding guide device comprises a rack which transmit power transmitted from a driving source via a pinion on the surface, and is assembled to enable sliding along the guide pole provided in parallel with the optical axis in an outer peripheral part of the sliding motion path of the lens driven for image focusing to focus the image.

The sliding guide device connected to the main body preferably comprises a tubular shape through which the guide pole can be inserted.

The sliding guide device connected to the main body preferably comprises a surface for making the guide pole slide, made of a resin or a metal.

The rack formed on the surface of the sliding guide device of the lens holding frame preferably has a tooth width equal to or narrower than the width of the sliding guide device.

The rack formed on the surface of the sliding guide device connected to the main body is preferably formed continuously in the direction parallel with the center axis of the guide pole.

The rack formed on the surface of the sliding guide device connected to the main body is preferably formed so that when the lens holding frame is viewed from the optical axis direction, an imaginary line intersecting at right angles with the rack surface passes through any position in the cross-sectional circle of the guide pole.

The lens holding frame is preferably provided with a mounting plane for attaching a position detecting reflector for detecting the position of the lens held by the lens holding frame.

In the lens holding frame according to the present invention, the mounting plane for the position detecting reflector is preferably formed on the sliding guide device of the lens holding frame.

The present invention provides the lens driving device using the above-described lens holding frame.

The present invention provides the imaging device using the above-described lens holding frame.

The lens holding frame according to the present invention is composed of a main body of the lens frame and the sliding guide device connected to the outer edge of the main body. In addition, the sliding guide device is installed to slide along to the guide pole provided in parallel with the optical axis, and then fluctuation of the optical axis in the lens motion is made small. Also, since the lens motion is made smoother, the sliding surface of the sliding guide device is hardly scrubbed to result excellent durability. Further, a complicated mechanism is not required for motion of the lens. As the result, when the lens holding frame according to the present invention is applied, the lens driving device may perform steady and highly accurate operation and excellent durability together with down-sizing.

Since the lens driving device according to the present invention comprises the above-described lens holding frame having excellent performance, a high-quality imaging device or optical device can be provided in which fluctuation of optical axis in the lens motion is prevented.

### BRIEF DESCRIPTION OF THE DRAWINGS

FIG. 1 is a perspective view of a first lens holding frame according to the present invention;

FIG. 2 is a perspective view of a second lens holding frame according to the present invention;

FIG. 3 is a perspective view showing an embodiment of a lens driving unit using the first lens holding frame according to the present invention;

FIG. 4 is a perspective view showing an embodiment of a lens driving unit using the second lens holding frame according to the present invention;

FIG. 5 is a bird view of a lens driving device using the lens holding frames according to the present invention;

FIG. 6 is a sectional view taken along the line A-A′ of FIG. 5;

FIG. 7 is a schematic side view showing the positional relationship between the rack and the pinion in the lens driving unit shown in FIG. 3;

FIG. 8 is a schematic side view showing the positional relationship between the rack and the pinion in the lens driving device according to the present invention; and

FIG. 9 is a perspective view of the lens driving device shown in FIG. 5.

### DETAILED DESCRIPTION OF THE PREFERRED EMBODIMENTS

A preferred embodiment of a lens holding frame according to the present invention will be described.

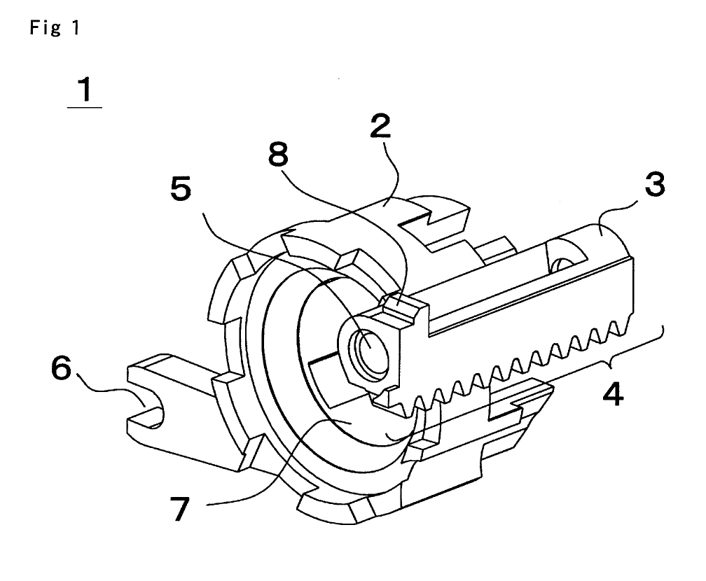

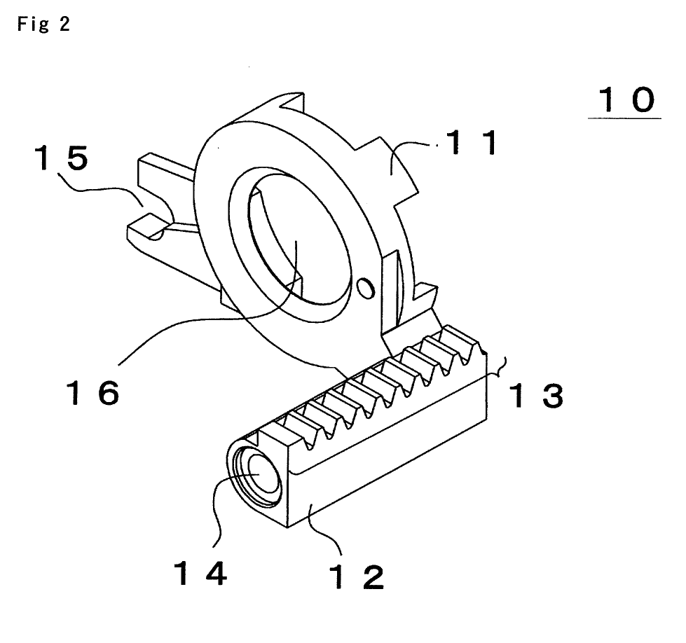

FIGS. 1 and 2 are perspective views showing embodiments of lens holding frames according to the present invention. The lens holding frames 1 and 10 according to the present invention are composed of the lens frame bodies 2 and 11 and the sliding guide devices 3 and 12 connected to the outer edge part of the lens frame bodies 2 and 11.

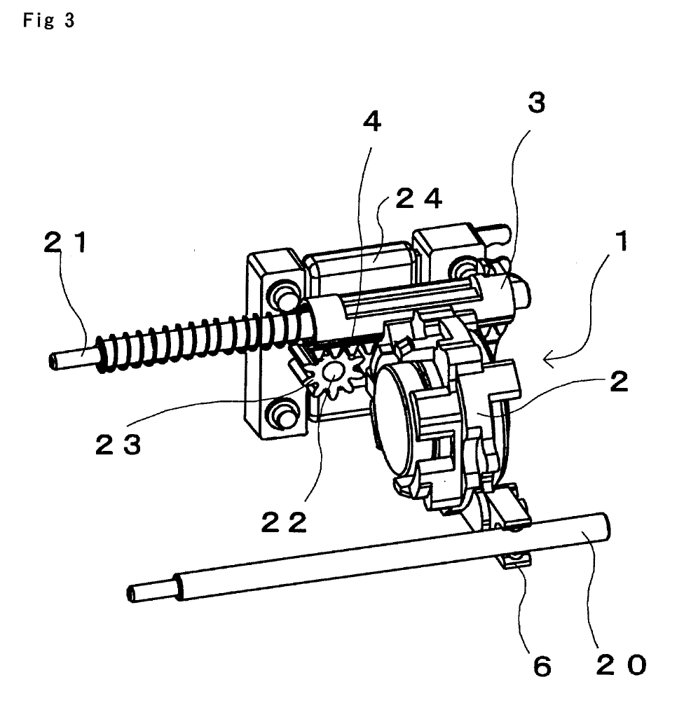

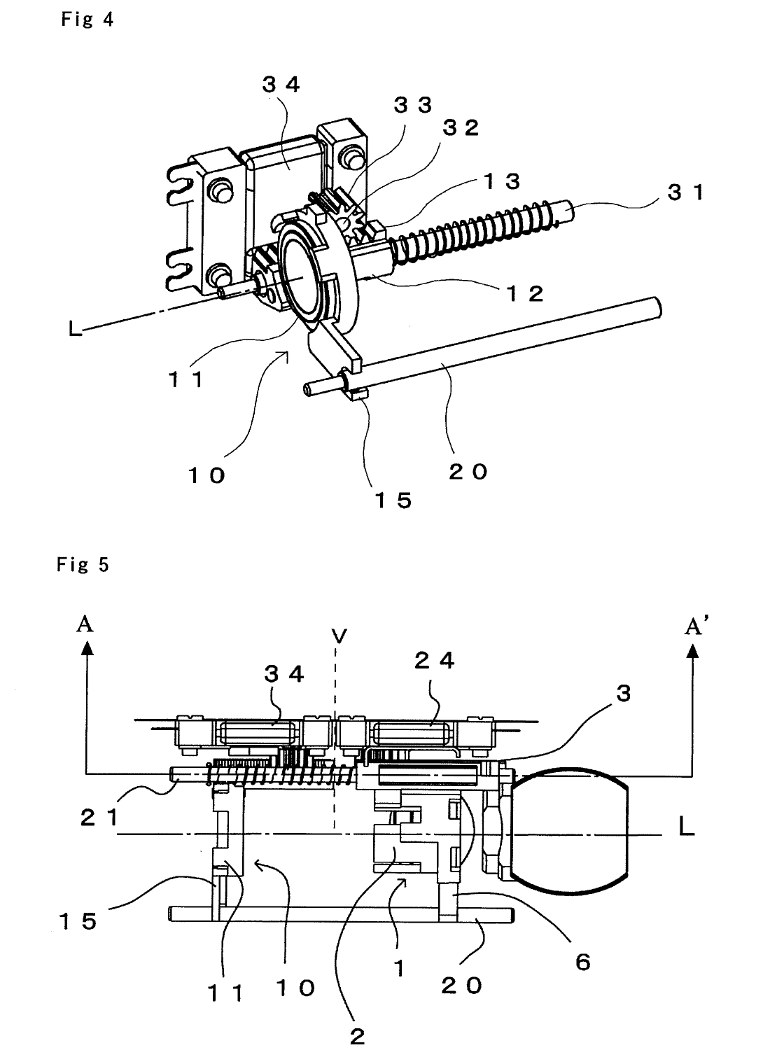

First, the basic constructions of lens driving units using the lens holding frames according to the present invention will be described with reference to FIGS. 3 and 4. FIGS. 3 and 4 are perspective views for showing a mechanism for sliding the lens holding frames 1 and 10 for holding the lens group for the imaging device in parallel with the optical axis L by using the motors 21 and 34. FIG. 3 is a perspective view of the lens driving unit using the lens holding frame 1 shown in FIG. 1, and FIG. 4 is a perspective view of the lens driving unit using the lens holding frame 10 shown in FIG. 2. As shown in FIGS. 3 and 4, the guide poles 21 and 31 are provided in parallel with the optical axis L in the outer peripheral part of the sliding motion path of the lens driven for image focusing, and the lens holding frames 1 and 10 slides along the guide poles 21 and 31. That is to say, the pinions 23 and 33 connected to the motors 24 and 34 are geared with the racks 4 and 13 formed in the sliding guide devices connected to the lens holding frames 1 and 10, by which the driving force of the motors 24 and 34 are transmitted to the lens holding frames 1 and 10 via the pinions 23 and 33, and therefore the lens holding frames 1 and 10 move along the guide poles 21 and 31.

As shown in FIGS. 1 and 2, the lens frame bodies 2 and 11 of the lens holding frames 1 and 10 according to the present invention are provided with the lens mounting parts 7 and 16 in the central part thereof. The lens groups for imaging device are fixed in the lens mounting part 7 and 16 so as to fit therein, by which the lens groups are held to align in the optical axis with the fixed lens (not shown) provided in the lens tube. The lens groups for imaging device are formed by combining a plurality of lenses and arranging them so as to align in their optical axes L with each other. As the lens, a focusing lens, a zooming lens, or the like are used. The optical zooming function or the focusing function can be performed by sliding the lens holding frame holding the zooming lens or the focusing lens along the optical axis L in the lens tube.

The sliding guide devices 3 and 12 may be connected to any position in the outer edge part of the lens frame body 2 and 11 where the guide devices are connected to be able to slide along the guide poles 21 and 31 at least. To be so, at least the shape of the inner surface where it slide with the guide poles 21 and 31 of the sliding guide devices 3 and 12 should corresponds to the outer peripheral shape of the guide poles 21 and 31. For example, the vertical cross sectional view with respect to the optical axis of the guide poles 21 and 31 may be a substantially U shape. In particular, as shown in FIGS. 1 and 2, the sliding guide devices 3 and 12 comprise a tubular shape 5 and 14 through which the guide poles 21 and 31 can be inserted. When the lens holding frames 1 and 10 are connected to be able to slide along the guide poles 21 and 31, inserting of the guide poles 21 and 31 in the tubular shape 5 and 14 make the sliding motion of the lens holding frames 1 and 10 more stable.

Also, the sliding guide devices 3 and 12 comprise the racks 4 and 13 to which power transmitted from a driving source is transmitted through the pinions 23 and 33. The racks 4 and 13 gears with the pinions 23 and 33 to make the lens holding frames 1 and 10 slide. In addition, the sliding guide devices 3 and 12 are provided with the collision preventing stopper 8 for preventing excessive sliding motion of the lens holding frames 1 and 10. The lens driving device also comprises a collision preventing stopper receiving part at the position adjacent to the lens holding frames 1 and 10 and the collision preventing stopper 8 regulates the sliding motion at the position of abutting on the collision preventing stopper receiving part in the state in which the lens holding frames 1 and 10 are mounted at a predetermined position of the lens driving device. Further, the auxiliary supports 6 and 15 are connected in the lens holding frames 1 and 10 according to the present invention at the outer edge of the lens frame body 2, in addition to the sliding guide devices 3 and 12.

To perform a mechanism for driving the lens group for changing focal distance and the lens group for focusing independently, a case when a plurality of lens holding frames are provided is assumed in the lens holding frame according to the present invention. The example in which two lens groups are used will be described with reference to the drawings where the two lens holding frames as a first lens holding frame and a second lens holding frame are provided to demonstrate embodiment of the lens holding frame according to the present invention.

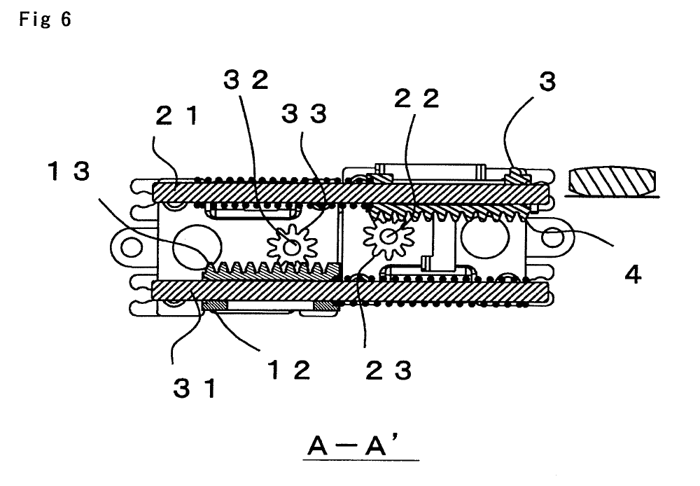

FIG. 5 is a bird view showing a construction of the lens driving device comprising the first lens holding frame and the second lens holding frame according to the present invention. FIG. 6 is an A-A′ sectional view of the lens driving device, taken along the line A-A′ of FIG. 5. Then, the construction of the lens driving device using the lens holding frames according to the present invention will be described with reference to FIGS. 5 and 6.

As shown in FIG. 6, the guide pole 21 is inserted through the sliding guide device 3 connected to the first lens holding frame 1, and the guide pole 31 is inserted through the sliding guide device 12 connected to the second lens holding frame 10, so, the sliding guide devices 3 and 12 are enabled to slide in parallel with the optical axis L shown in FIG. 5. In addition, the auxiliary support 6 connected to the first lens holding frame 1 and the auxiliary support 15 connected to the second lens holding frame 10 are settled to an auxiliary guide pole 20. A means for sliding the lens holding frame according to the present invention is a gearing structure of the racks 4 and 13 and the pinions 23 and 33 as shown in FIG. 6. That is to say, the driving force of the motors 24 and 34 are transmitted to the racks 4 and 13 via the pinions 23 and 33, and then the lens holding frames 1 and 10 are made slide. By adopting the gearing structure of rack and pinion as the lens moving means, even when the auxiliary guide pole 20 is absent, the fluctuation of optical axis of lens in the lens sliding can be made small as compared with the engaged structure of bolt and nut. Further, to reduce a load on the gear part of rack and pinion and to further reduce the fluctuation of optical axis of lens in the lens sliding, it is preferable to provide the auxiliary guide pole 20. When the auxiliary guide pole 20 is provided, the lens holding frames 1 and 10 should be provided with the auxiliary supports 6 and 15 to be settled to the auxiliary guide pole 20.

In the lens holding frame according to the present invention, the sliding guide device connected to the main body comprising a surface for making the guide pole slide is preferably made of a resin or a metal. The sliding guide device according to the present invention comprises a tubular shape through which the guide pole can be inserted to perform a function as a sleeve. Also, the inner wall surface of the tubular shape provided in the sliding guide device, through which the guide pole can be inserted, may be coated with grease or the like to improve the sliding ability. A resin-made or metal-made sleeve may be provided to be the sliding surface in the sliding guide device according to the present invention. When the resin-made or metal-made sleeve is provided in the sliding surface, even if the sliding surface of the provided sleeve is wear, the lens holding frame having been used can be maintained by just replacing the sleeve.

Furthermore, in the combination structure of the metal-made sleeve and the guide pole according to the present invention, the sliding surface between the inner periphery of the metal-made sleeve and the guide pole is preferably coated with a diamond-like carbon film (hereinafter, referred simply to as a “DLC” film). DLC is the general term of a carbon thin film material like a diamond. However, DLC comprises carbon as an essential component and some hydrogen to compose an amorphous structure in which a crystal grain boundary does not comprise a diamond bond and/or a graphite bond. As the result, DLC has excellent surface smoothness as compared with the hard thin film comprising polycrystalline structure such as titanium nitride. Because, DLC has a hardness equivalent to that of diamond, and also has a friction coefficient (μ) of about 0.1, DLC has an excellent frictional wear resistance (tribology characteristic). That is to say, when the inner surface of the metal-made sleeve is coated with the DLC film, the sleeve exhibits an excellent frictional wear resistance. Therefore, when the DLC film is used on a sliding member, the durability can be made excellent.

For the lens holding frame according to the present invention, the rack formed on the surface of the sliding guide device of the lens holding frame preferably has a tooth width equal to or narrower than the width of the sliding guide device. When the tooth width of the rack formed on the surface of the sliding guide device is equal to or narrower than the width of the sliding guide device, the size of the sliding guide device can be reduced. Therefore, when the sliding guide device is used in the lens driving device, the layout of other members may be made free.

Next, the material utilized for the tooth part of the rack will be described briefly. As for a steel material, carbon steel (S35C to S48C) and alloy steel (SCM, SNCM, SCr) are the material mainly used for power transmission. The durability of the steel materials can be improve by surface hardening treatment such as quenching and tempering treatment, carburizing treatment, or nitriding treatment. On the other hand, a resin material is excellent in light weight, higher vibration absorption, no need for the rust proofing treatment, the self-lubricating property, and low cost. However, it is inferior to a metallic material in hardness and strength. Therefore, the resin material is used mainly for OA equipment, precise machines, and the like as a material for motion transmission. Also, the surface of the tooth part of the rack may be coated with the diamond-like carbon film to make it hard.

For the lens holding frame according to the present invention, the rack formed on the surface of the sliding guide device connected to the main body is preferably formed continuously in the direction parallel with the center axis of the guide pole. By the way, the position of the racks 4 and 13 formed on the surface of the sliding guide devices 3 and 12 are not limited to the position shown in FIG. 6. As the position may be arranged at where the rack gears with the pinion on either of the surfaces of the sliding guide device, the position can be changed freely in accordance with the arrangement of the pinion and motor. In such a gear structure of rack and pinion, when the position of the rack is made to parallel with the guide pole in the sliding guide device, the driving force can be transmitted smoothly, and therefore the sliding motion of the lens holding frame is made more stable.

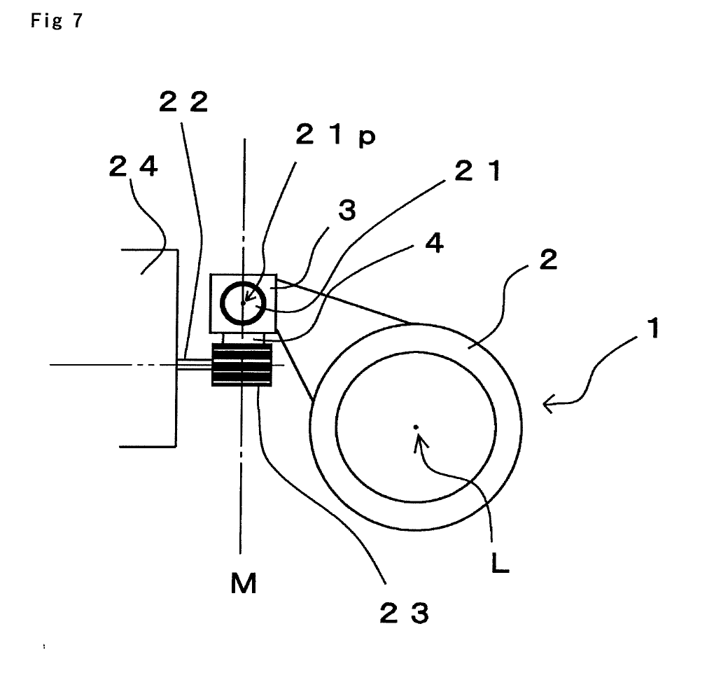

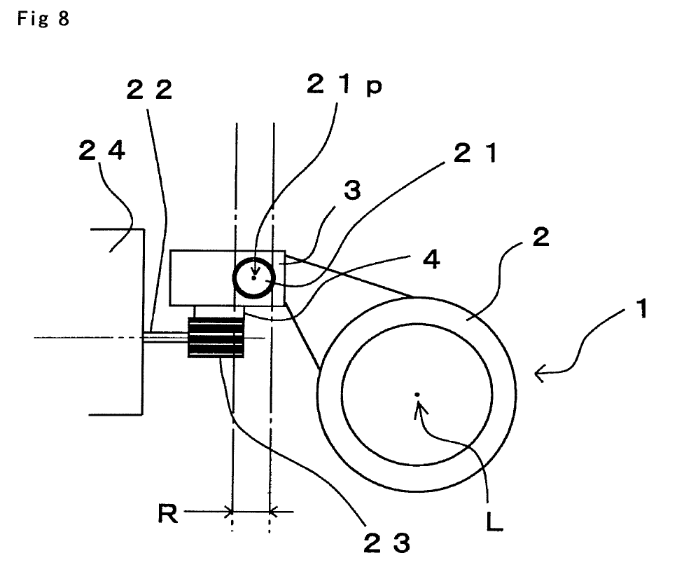

In the lens holding frame according to the present invention, the rack formed on the surface of the sliding guide device connected to the main body is preferably formed so that when the lens holding frame is viewed from the optical axis direction, an imaginary line intersecting at right angles with the rack surface passes through any position in the cross-sectional circle of the guide pole. The arrangement of a drive transmission means viewed from the optical axis direction will be described with reference to FIGS. 7 and 8. FIG. 7 is a schematic side view of the drive transmission means of the lens driving unit shown in FIG. 3, being viewed from the lens surface side, and FIG. 8 is a schematic side view for showing a modified example of the arrangement of drive transmission means. When the rack 4 is formed on the surface of the sliding guide device 3 at the position shown in FIGS. 7 and/or 8, the drive transmission means can be arranged close to the guide pole 21 where the sliding guide device 3 slides. As the result, as compared with when the rack 4 is provided at another place of the lens holding frame 1, the moment generated by the driving force decreases to make motion of the sliding guide device 3 along the guide pole 21 stable to result the sliding motion of the lens holding frame 1 more stable.

The arrangement of the drive transmission means viewed from the optical axis direction may be allowed to be formed on either of the surfaces of the sliding guide device 3. For example, the rack 4 may be formed at a position extending from the sliding guide device 3. Preferably, as shown in FIG. 8, when the guide pole 21 is settled to the sliding guide device 3, at least a part of the gear surface between the rack 4 and the pinion 23 viewed from the optical axis direction may be arranged close to the extension line of the slide part of the sliding guide device 3 and the guide pole 21 (within a region R shown in FIG. 8). Such arrangement is preferable because the lens holding frame 1 is made slide stably, and the arrangement space of the lens holding frame 1 and the drive transmission means can be reduced.

The most preferable embodiment when being viewed from the optical axis direction is that the drive transmission means are arranged at a position where an imaginary line M intersecting at right angles with the gear surface between the rack 4 and the pinion 23 passes through the section center 21p of the guide pole 21 as shown in FIG. 7. In this case, the moment generated by the driving force is made minimum, and the sliding guide device 3 moves stably along the guide pole 21 to make the sliding motion of the lens holding frame 1 more stable. Also, when the arrangement shown in FIG. 7 is adopted, the width of the lens driving unit viewed from the optical axis can be reduced.

Next, the lens driving device 40 according to the present invention will be described. In the lens driving device 40 according to the present invention, the lens driving unit comprising the first lens holding frame 1 and the lens driving unit comprising the second lens holding frame 10 each comprise same motors 24 and 34, same racks 4 and 13, same pinions 23 and 33, and same guide poles 21 and 31 in same construction respectively. The sliding guide device 3 of the first lens holding frame 1 and the sliding guide device 12 of the second lens holding frame 10 are arranged adjacently at positions that are axially symmetrical with respect to a reference line V intersecting at right angles with the optical axis L as shown in FIG. 5.

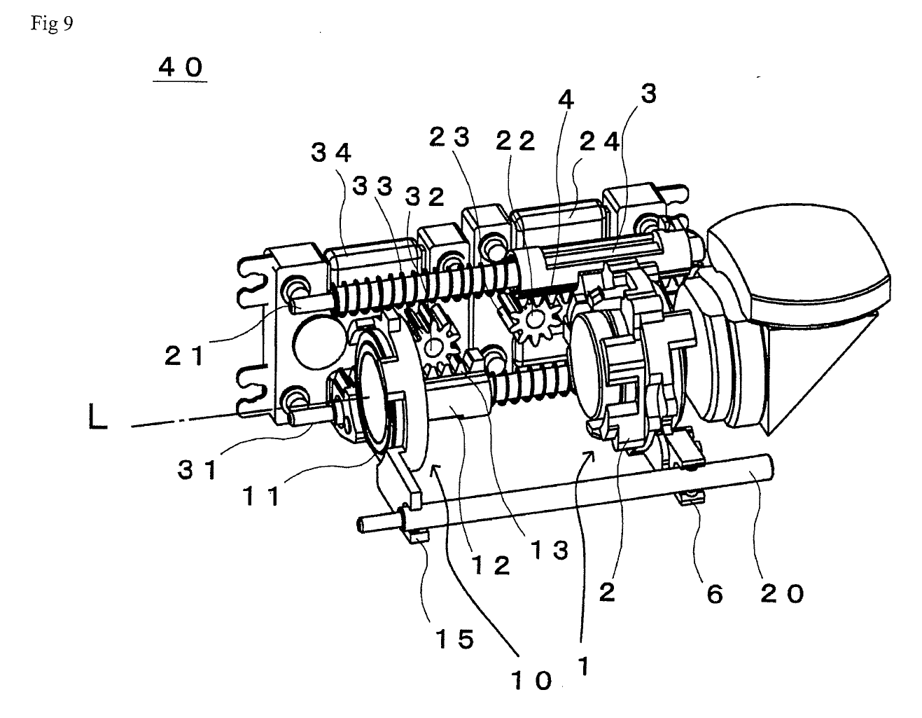

In addition, the pinions 23 and 33 are arranged at positions offset from a middle point between the separatedly arranged first guide pole 21 and second guide pole 31 in the lens driving unit as shown in FIGS. 5 and 9. In the example shown in FIGS. 6 and 9, the pinions 23 and 33 are arranged at positions offset from the center position of the housing of motor. If the lens driving unit comprising the first lens holding frame 1 and the lens driving unit comprising the second lens holding frame 10 are arranged at positions axially symmetrical with respect to the reference line V, the lens driving device 40 according to the present invention can be laid out without a useless space to enable the constituent members of the first lens driving units, which are driven independently, do not interfere with each other. In addition, since the sliding motion path of the lens holding frames 1 and 10 are made long, the relative position is made highly flexible, and therefore the lens driving device 40 can perform a high-magnification zooming function in small size.

FIG. 9 is a perspective view showing an embodiment in the case where the lens holding frames according to the present invention is applied for the lens driving device. Then, the construction of the lens driving device using the lens holding frames according to the present invention will be described with reference to FIG. 9. In FIG. 9, the arrangement of elements where the pinion 23 connected to the motor 24 is geared with the rack 4 of the sliding guide device 3 connected to the first lens holding frame 1, and the pinion 33 connected to the motor 34 is geared with the rack 13 of the sliding guide device 12 connected to the second lens holding frame 10 is shown to make understanding easy. As described above, arrangement of the elements at such positions where the lens holding frames 1 and 10 according to the present invention are used for the lens driving device, the space can be saved without hindering the layout of other members and it enables the size reduction of the lens driving device. The length in the optical axis L direction of the sliding guide devices 3 and 13 may be equal to or longer than the length of the racks 4 and 13 formed on the outer surface of the sliding guide devices 3 and 13.

Also, the output shafts of the motor 24 for sliding the first lens holding frame 1 and the motor 34 for sliding the second lens holding frame 10 can be disposed at right angles to the optical axis L. So, the motors serving as a driving source for sliding the lens holding frame according to the present invention in the optical axis direction are preferable for space saving to be a flat motor having a small thickness in the output shaft direction.

It is preferable that the lens holding frame according to the present invention is provided with the mounting plane for the position detecting reflector formed on the sliding guide device of the lens holding frame. This is because that when the system comprises a light source emits a light, a reflector reflects the light emitted from the light source, and a sensor receive the reflected light, the position of lens can be detected by converting the light received by the sensor into a signal by an arithmetic circuit. On the reflector, a bar code-like pattern may be printed, and the pattern is composed of portions where light is reflected and where light is not reflected. That is to say, when the reflected light sensor receives the light emitted from the light source, the arithmetic circuit converts the ratio of the portion with light reflection and the portion without light reflection into a pulse wavelength, and the positional information of the reflector is detected by the change of the wavelength. It means that, the position of lens can be informed more accurately by providing the reflector on the lens holding frame and the accuracy of positioning of the lens is made excellent. Further, even when the lens is replaced subsequently, the provided lens holding frame does not cause deviation in lens positioning by the replacement of lens. The mounting plane for a position detecting reflector is preferably formed on the sliding guide device of the lens holding frame. The reason why is that the sliding guide device is settled to the guide pole, and is the portion where effect of the lens motion hardly affect on accuracy.

The lens holding frame according to the present invention is preferably used for the lens driving device. When the lens holding frame for the lens driving device is used, in the lens driving device, the fluctuation of optical axis of lens is reduced, the accuracy of lens positioning is made excellent, and high quality and accuracy are assured with down-sizing.

The lens holding frame according to the present invention is preferably used for the imaging device. As described above, when the lens holding frame for the imaging device is used, in the imaging device, high quality and accuracy are assured with down-sizing.

It should be noted that the lens driving device for which the lens holding frame is used is not limited to the lens driving device described in this embodiment.

When the lens holding frame according to the present invention is applied, the imaging device comprising auto-focusing function and zooming function performed by continuously changing the focal distance can be down-sized while assuring steady and highly accurate operation.

The lens holding frame according to the present invention can be suitably used not only for the imaging device but also for various kinds of optical devices when the devices utilize a rack and pinion for the lens driving mechanism. For example, in an optical disc device utilizing an optical system using the lens driving device for recording and reading, an objective lens driving device is provided for focusing a laser beam exactly on the information pit on the disc to write and read an information signal on the disc. When the lens holding frame according to the present invention is applied to the objective lens driving device, steady and highly accurate operation and down-sizing can be achieved in the product and it performs a high-durability and high-quality.

What is claimed is:

1. A lens holding frame for holding a lens driven for image focusing which is made able to slide used for an imaging device, wherein,
the lens holding frame is composed of a main body of a lens frame and a sliding guide device connected to the outer edge of the main body; and
the sliding guide device comprises a rack which transmit power transmitted from a driving source via a pinion on the surface, and is assembled to enable sliding along a guide pole provided in parallel with the optical axis in an outer peripheral part of the sliding motion path of the lens driven for image focusing to focus the image.

2. The lens holding frame according to claim 1, wherein the sliding guide device connected to the main body comprises a tubular shape through which the guide pole can be inserted.

3. The lens holding frame according to claim 1, wherein the sliding guide device connected to the main body comprises a surface for making the guide pole slide, made of a resin or a metal.

4. The lens holding frame according to claim 1, wherein the rack formed on the surface of the sliding guide device of the lens holding frame has a tooth width equal to or narrower than the width of the sliding guide device.

5. The lens holding frame according to claim 1, wherein the rack formed on the surface of the sliding guide device connected to the main body is formed continuously in the direction parallel with the center axis of the guide pole.

6. The lens holding frame according to claim 1, wherein the rack formed on the surface of the sliding guide device connected to the main body is formed so that when the lens holding frame is viewed from the optical axis direction, an imaginary line intersecting at right angles with the rack surface passes through any position in the cross-sectional circle of the guide pole.

7. The lens holding frame according to claim 1, wherein the lens holding frame is provided with a mounting plane for attaching a position detecting reflector for detecting the position of the lens held by the lens holding frame.

8. The lens holding frame according to claim 7, wherein the mounting plane for the position detecting reflector is formed on the sliding guide device of the lens holding frame.

9. A lens driving device using the lens holding frame according to claim 1.

10. An imaging device using the lens holding frame according to claim 1.
